(19) United States
(12) Patent Application Publication
(10) Pub. No.: US 2003/0234819 A1
(43) Pub. Date: Dec. 25, 2003

(54) Systems and methods for providing media content

(75) Inventors: Elizabeth Aries Daly, Medfield, MA (US); Peter Dominic Brandano III, Newton, MA (US); Christopher John Brophy, Cohasset, MA (US); Steven Michael Bryer, Needham, MA (US)

Correspondence Address: HOWREY SIMON ARNOLD & WHITE LLP, BOX 34, 1299 PENNSYLVANIA AVENUE NW, WASHINGTON, DC, 20004, US

(73) Assignee: General Dynamics C4 Systems, Inc.

(21) Appl. No.: 10/464,540

(22) Filed: Jun. 19, 2003

Related U.S. Application Data
(60) Provisional application No. 60/390,464, filed on Jun. 24, 2002.

(51) Int. Cl. G09G 5/00

(52) U.S. Cl. 345/810

(57) ABSTRACT

The inventions relate to systems and methods for providing interactive media content with an easy-to-use graphical user interface. The inventions include simplifying improvements to the user interface of a networked system of servers providing advertising, games, internet, video, and other services. Improvements include a plurality of panels for the simultaneous display of a plurality of media, a promotion scheduler for controlling the content of the panels, a simplified means for making purchases, and a simplified means for navigating through layers of multiple options.

### CROSS-REFERENCE TO RELATED APPLICATIONS

This application claims priority to U.S. Provisional Patent Application Serial No. 60/390,464, filed Jun. 24, 2002, incorporated herein by reference.

### BACKGROUND

The hospitality industry often provides in-room entertainment services to its guests through computer systems which allow guests to control media content provided to their hotel rooms. These systems can provide media content of the guests' choice such as movies or games through a menu driven video user interface. However, such systems often lack user-friendly interfaces, often requiring guests to fumble with a remote using non-intuitive controls. Such systems typically do not make optimal use of television screens. Furthermore, such systems lack intelligent designs for providing useful targeted information and advertising to guests.

### SUMMARY OF THE INVENTION

The present invention provides substantial improvements to in-room entertainment services within the hospitality industry. The invention provides user-friendly interfaces with easy-to-use navigation controls. The invention further provides a multiple window environment, allowing the entertainment services to make optimal use of a television screens. The invention further provides intelligent designs for providing useful targeted information and advertising to guests through a promotion scheduler.

In one aspect, the invention includes a system for providing media content comprising a means for providing audio and video signals, a means for receiving the audio and video signals connected to the means for providing audio and video signals through a local area network, a means for displaying the audio and video signals, a means for sending control signals, wherein the control signals indicate the media content to be provided, a means for receiving control signals from the means for sending control signals, and software for providing an interactive graphical user interface, wherein the graphical user interface includes a plurality of media panels with media contents on a display screen, and wherein the media content of at least one of the media panels changes in response to the control signals received by the means for receiving control signals.

In one embodiment, the means for providing audio and video signals may be a video server, and the means for receiving the audio and video signals may be a set-top box. In another embodiment, the means for displaying the audio and video signals may be a television set. In an alternative embodiment, the means for displaying the audio and video signals may be a computer monitor. In one embodiment, the means for sending control signals may be an infrared remote control. In one embodiment, the means for receiving control signals may be a set-top box. In one embodiment, the media contents of at least one of the media panels is an advertisement, which may be a directed advertisement. In this embodiment, a single push of one or more selection keys may be used to purchase the object of the advertisement. In one embodiment, the system may further include a controlling database for specifying media contents to be displayed in the media panels. In one embodiment, the graphical user interface includes menu options that may be navigable and selectable using said means for sending control signals. In one embodiment, the means for sending control signals may include one or more directional controller and one or more selection keys, wherein the one or more directional controllers may be used to navigate through the menu options, and the one or more selection keys may be used to select menu options.

In another aspect, the invention includes a method of providing advertising in a system for providing media content, the method comprising the steps of providing a graphical user interface with a plurality of media panels on a display, wherein each media panel displays media content, querying a database, the database containing a table listing promotional items in association with promotion text data and data indicating a duration of time, wherein the promotional items may be static graphics, active graphics, scrolling text, video, and/or audio advertisements. The method may further include the steps of displaying at least one of the promotional items in at least one of the media panels for a duration of time indicated by the data indicating a duration of time in association with at least one of the promotional items, and displaying the promotion text data in association with the displayed promotional items. In one embodiment, the promotional item may be a video or audio advertisement, and the duration of time may correspond to the duration of the video or audio advertisement. In another embodiment, the promotional item may be an active graphic or scrolling text, and the duration of time may correspond to the time required for at least one cycle of the active graphic or scrolling text.

### DESCRIPTION OF THE FIGURES

FIG. 1 shows a multimedia panel layout for use in the systems of the invention.

FIG. 2 shows selection buttons used for navigation through the systems of the invention.

FIG. 3 shows an example of the functionality of the promotion scheduler of the invention.

FIG. 4 shows an example of function tab selection used for navigation through the systems of the invention.

### DETAILED DESCRIPTION OF THE INVENTION

This invention relates to systems and methods for providing media content to media consumers in an interactive environment. In a preferred embodiment referred to herein as the “Intrigue System,” the invention may include a system capable of providing an interface for multimedia, electronic commerce, internet, television signals, video, games, and other services for the hospitality industry. In this embodiment, the system may provide these services, for example, to guests in hotel rooms or to business persons in conference rooms within a hotel. In other embodiments, the system may provide services to rooms in motels, timeshares, resorts, apartments, condominiums, or any other group of rooms with media outlets.

The Intrigue System is a platform that may include an integrated computer system and components including video servers, web access servers, proprietary and third party software, set-top boxes, mechanical components, materials, and supplies assembled and integrated into a complete system. The Intrigue System may be comprised of the following major components: (1) a video server for video-on-demand, (2) digital set-top boxes, (3) operating system software, (4) a high speed local area network, (5) a web server for information services, (6) a network management collection station, (7) a firewall server, (8) an uninterrupted power supply, and (9) a hand-held infrared remote control (IR remote). Infrared keyboards or other remote or hard-wired input devices may also be connected to the Intrigue System. Preferably, the set-top boxes are actively connected to the television sets, allowing the user to control such television settings as power, channel, and volume via the remote through the set-top box.

In a preferred embodiment, the Intrigue System operates on a Gigabit Ethernet network. The video streaming capability preferably uses MPEG2 transport in Gigabit Ethernet cells. The data network supporting the various services preferably uses internet protocol (IP) over a Gigabit Ethernet network. The backbone network preferably consists of one Gigabit Ethernet switch and one 10/100 Ethernet switch with one Gigabit Ethernet port located in a centralized area, for example in a main equipment room in a hotel, and several 10/100 Ethernet edge switches, each with one Gigabit Ethernet port located, for example, in equipment closets on the various floors of a hotel. All servers are preferably hard-wired to each set-top box located in the hotel. The Intrigue System is combined with and integrated into a digital local area network (LAN) to provide services such as video-on-demand, electronic commerce, electronic advertising, and internet access. The Intrigue System preferably includes the following types of software: (1) an interactive user interface, (2) application software, (3) network management software, (4) adult movie content blocking software, and (5) internet content screening software.

In one embodiment, the Intrigue System includes video-on-demand services provided by at least one video server. A viewer may order a movie offered through the Intrigue System through a series of entries using an infrared remote. In this embodiment of the invention, the Intrigue System has the ability to host up to seventy five (75) movie offerings, with each video server hosting at least 150 hours of video content. Generally, however, there is no upper or lower limit to the number of movie offerings. Preferably, the Intrigue System has sufficient video servers to simultaneously supply at least fifteen percent (15%) of the total number of hotel guest rooms and conference rooms containing set top boxes. Preferably, users of the video-on-demand services may control their movie viewing through such features as pause, stop, rewind, and fast forward. A preferred feature of video-on-demand allows the user to select to restrict access to adult content by making a “blocking” selection through a movie menu using an infrared remote. In a preferred embodiment, the video client is an ActiveX control running in a panel, thus allowing MPEG2 videos to be displayed. In an alternative embodiment the video client is a LINUX program for displaying MPEG2 videos. In a second alternative embodiment, the video client is any suitable video display program for displaying any suitable format of video.

Preferably, the Intrigue System is capable of providing high speed internet access, for example through a personal computer or a television set. If internet access is offered through a television set, the user may provide input through an infrared remote, an infrared keyboard, or any other infrared or hard-wired input device. In this embodiment, the Intrigue System acts as the interface and provides internet functionality to the television in a hotel room by facilitating access to, for example, internet web sites on the world wide web through the hotel's internet service provider. In this embodiment, internet service is preferably provided through the television set-top box. In an alternative embodiment, internet service is provided by providing an Ethernet port to connect the set-top box to a personal computer. In a preferred embodiment, the Intrigue System includes firewall protection to inhibit unauthorized intrusion from outside the local area network. Preferably, this embodiment further includes a blocking feature to allow hotel guests or employees to restrict access to certain categories of internet sites, either on a room-by-room or a hotel-wide basis. Most preferably, hotel guests may restrict access in their rooms, and authorized hotel management personnel may restrict access on a room-by-room and hotel-wide basis.

In a preferred embodiment, the Intrigue System is capable of identifying, describing, and defining custom content for the hotel in which the system resides. In this embodiment, the Intrigue System can utilize information pertaining to the hotel and other local information, and can display this information. Preferably, the Intrigue System is programmed to display a plurality of site-specific screens, including internet Web pages. For example, the Intrigue System may display site-specific videos, “welcome tour” videos, maps, room service menus, facility directories, restaurant information, spa/health club/pool information, hotel bill information, business center information, TV channels and guides, and special events. The Intrigue System may also display local information including information on area restaurants, entertainment, shopping, and city guides.

In a preferred embodiment, the Intrigue System provides users with the capability to access commercial internet web sites for internet based electronic shopping. For simplicity of use, the user is preferably able to select a shopping icon to engage in electronic shopping.

In a preferred embodiment, the Intrigue System is interfaced with the hotel's transaction-based billing system to allow tracking and billing for services provided. In this embodiment, a hotel guest may review his hotel bill including any room charges. In another embodiment, a hotel guest may additionally conduct payment transactions with the hotel and other vendors and service providers through the Intrigue System.

In a preferred embodiment, the Intrigue System is configured to provide access to the hotel's television service.

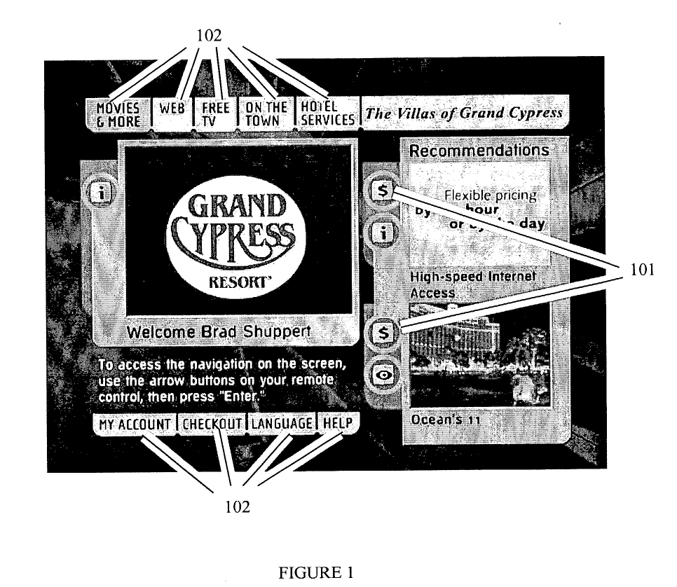

One aspect of the invention includes a system and method for displaying multiple simultaneous media panels on a display screen to present information on a variety of topics and utilizing multiple media types including video, graphics, animation, scrolling text, and audio including but not limited to radio, internet radio, cable radio, satellite radio, and local audio sources. Preferably, this system and method is used in conjunction with the Intrigue System as described above and as shown in FIG. 1. Any number of individual multimedia panels are displayed on the display screen simultaneously. In a preferred embodiment, up to four (4) individual multimedia panels are displayed on the display screen simultaneously. In the most preferred embodiment, three individual multimedia panels are displayed on the display screen simultaneously. Preferably, all panels are programmed from the central database. This method allows the presentation of advertising simultaneously while the system is performing other functions, possibly involving active content or high-quality video.

The content in one or more of the plurality of panels is responsive to user selections that change the menu options. In a preferred embodiment described below, navigation among the menu options is simplified by the use of arrow keys on an infrared remote. Preferably, the menu options include a video selection menu, informational menus including information about local services, guests' hotel accounts, and help using the system, as well as selections allowing the guest to access the world wide web, watch television, or change language options within the system. When a user makes a selection changing the current menu options, the contents of one or more of the panels and corresponding graphical links are changed to provide the user the requested menu or information.

In a particularly preferred embodiment, the content of one or more active multimedia panels is responsive to the selections made by the user in any of the panels in a method of directed advertising. For example, if a user makes an on-screen selection requesting information about area restaurants, thus indicating an interest in dining, in addition to providing the requested information, the system might additionally display a paid advertisement for an area restaurant. Or if a user makes an on-screen selection requesting more information on or to watch a particular movie, thus indicating an interest in movies of that sort, the system might display a paid advertisement for another movie in the same genre. Preferably, when a user selects a movie, the screen automatically switches from panel mode to full-screen mode for movie viewing.

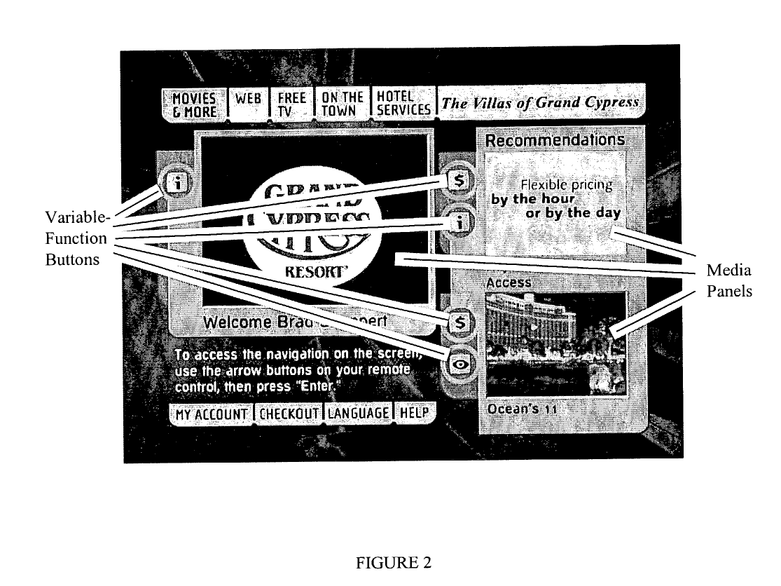

Content to be supplied to each of the panels may be driven by a controlling database which specifies the object (video or graphic) to be displayed along with the duration of the sequence. This database may additionally specify the functionality of the selection buttons adjacent to each of the panels, as shown in FIG. 2. The buttons adjacent to the panels may be made to appear, disappear, or change function, depending on the content being displayed at the time. The functionality and appearance of each panel and associated buttons may be controlled by the system servers running software that accesses look-up tables in the server databases to select the content for each active panel and the functionality of the associated buttons.

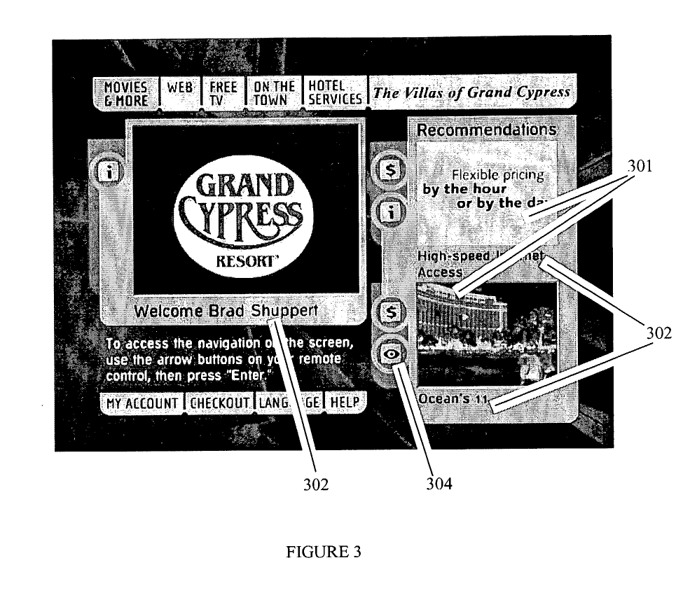

One aspect of the invention includes a system and method for scheduling promotions displayed on the Intrigue System, as shown in FIG. 3. The promotion scheduler of the invention can be a software program running on the system servers. The promotion scheduler may access a database containing a lookup table to determine the sequence, timing, and selection of promotional material to be displayed in each of one or more panels. The database servers may run any suitable database server software. The promotional materials and accompanying sequence and timing data may be remotely configurable and programmable as a group for hotel chains with similar promotions.

In a preferred embodiment, the promotion scheduler is executed when the main menu of the Intrigue System is accessed. The promotion scheduler queries a database for a list of promotions. Preferably, the database contains a table listing the promotional items by title. For example, the database may list the names of movies being promoted, or the brand name of a product, alphabetically or by any other means. Preferably, the title of the promotion is listed on the display, for example, at the top of the display. In the embodiment shown in FIG. 3, promotion titles 302 are listed below each panel 301 displaying an associated advertisement. Preferably, two links corresponding to each promotional panel are displayed. One link may be connected to the table of promotional information 303 or to preview a video 304 if a movie is being advertised, or may be programmed for any other suitable function. The other link may allow the user to purchase the product being displayed in that panel, as described in more detail below.

The promotion scheduler preferably includes a timing element that sets the length of time a particular promotion is displayed in a panel. The promotion scheduler may display static or active graphics, scrolling text, video, or audio advertisements. The length of time for a particular promotion as set by the timing element of the promotion scheduler may correspond to the length of an audio or video advertisement, the time required for a number of active graphic cycles to complete, or a preset or dynamically determined length of time. After the set time period for a particular displayed promotion expires, the promotion scheduler moves to the next promotional item listed in the table and changes the associated title displayed. At the time that the displayed promotion is changed, the associated links corresponding to the promotion are updated to correspond to the currently displayed promotion.

In an alternative embodiment, the promotion scheduler may access different promotions based on some external criteria to create an environment with personalized or customized advertising. For example, the promotions that are run late at night may include materials that are directed to adults, whereas promotions run during the day may include family oriented materials. Or the type of promotions that are run in any particular room may be varied based on known information regarding the guests in that room. For example, if a hotel guest is attending a convention at or near the hotel, promotional material regarding the subject matter of the convention may be run in that room. If a room contains guests that are a family, then family-oriented promotional materials may be displayed. Any other external criteria including time of day, characteristics and interests of the guests, and location of the hotel, for example, may be used to more accurately target promotional materials.

One aspect of the invention includes a system and method for allowing on-screen purchases of movies, products, media, or services using a single click of a remote or other input device. In a preferred embodiment, a user of the system may purchase a selection displayed in a panel using a single click of the “$” symbol 101, as shown in FIG. 1. In a preferred embodiment, the single-click system is used in conjunction with the display panels described above, providing the additional benefit of allowing users to click to purchase an item being actively promoted in one of the panels, thus reducing the complexity of purchasing items such as feature movies. This aspect of the invention may be implemented by the placement of a contextual purchase button adjacent to the promotion panel. The purchase button allows users to purchase the item being actively promoted in the panel without the need to navigate through hierarchical menus, thus providing a much easier means to purchase and resulting in more purchases of items such as movies, games, and internet access. In a preferred embodiment, a-second button is associated with each promotional panel, giving the user the ability to access additional information regarding the promotion.

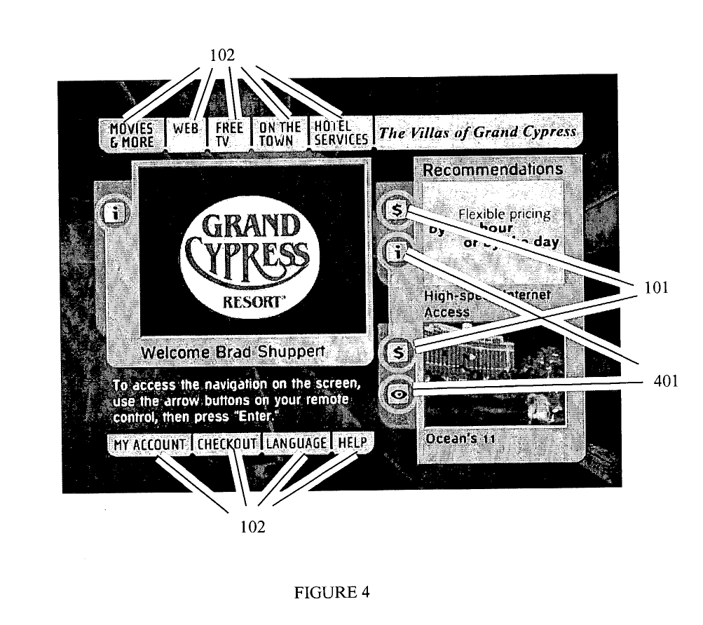

One aspect of the invention includes a system and method for navigating through branching menu options in the Intrigue System. This aspect of the invention provides an easy-to-understand graphical user interface with simple navigation controls. In a preferred embodiment, the interface provides on-screen function tabs for the user to select major menus and functions 102 and to make purchases 101 or request additional information 401 as shown in FIG. 4. Screen navigation by function tab selection may be performed by using the arrow keys on an infrared remote, or equivalent functions on an alternative input device. In alternative embodiments, function tab selection may be performed by using a control hat, input devices with two arrow keys, input devices with four arrow keys, an active thumbstick, or any other directional controller. In the preferred embodiment, four arrow keys on an infrared remote allow the user to highlight function tabs, and a fifth key, a select or enter key, for example, allows the user to select the currently highlighted function tab. This approach allows the user to navigate through complex branching menus without the need to look at the input device, thus making navigation easier, quicker, and allowing the use of additional screens for providing more options to users.

In a preferred embodiment, the system and method for navigating through menu options is implemented using Macromedia Flash for the creation of control graphics with background scripting of actions using Tango as an intermediary for database interactions. In alternative embodiments, other software tools may be used in place of Tango, for example ASP (active server pages), PHP (personal home pages), JAVA server pages, MacroMedia Cold Fusion, or any other suitable software tools. There is no limit in principle to the number of selections that can be provided to the user, and additional selections can be created using hierarchical menus as needed.

What is claimed is:

1. A system for providing media content comprising:
a means for providing audio and video signals;
a means for receiving said audio and video signals connected to said means for providing audio and video signals through a local area network;
a means for displaying said audio and video signals received by said means for receiving;
a means for sending control signals, wherein said control signals indicate the media content to be provided;
a means for receiving control signals from said means for sending control signals;
software for providing an interactive graphical user interface, wherein said graphical user interface includes a plurality of media panels with media contents on a display screen, and wherein a media content of at least one of said media panels changes in response to said control signals received by said means for receiving.

2. The system of claim 1, wherein said means for providing audio and video signals is a video server, and said means for receiving said audio and video signals is a set-top box.

3. The system of claim 2, wherein said means for displaying said audio and video signals is a television set.

4. The system of claim 2, wherein said means for displaying said audio and video signals is a computer monitor.

5. The system of claim 3, wherein said means for sending control signals is an infrared remote control.

6. The system of claim 3, wherein said means for receiving control signals is said set-top box.

7. The system of claim 6, wherein the media contents of one or more of said media panels is an advertisement.

8. The system of claim 7, wherein said advertisement is a directed advertisement.

9. The system of claim 7, further including a controlling database for specifying media contents to be displayed in said media panels.

10. The system of claim 6, wherein said graphical user interface includes menu options that are navigable and selectable using said means for sending control signals.

11. The system of claim 10, wherein said means for sending control signals includes one or more directional controller and one or more selection keys, and wherein said one or more directional controller is used to navigate through said menu options and said one or more selection keys is used to select menu options.

12. The system of claim 7, wherein a single push of said one or more selection keys is used to purchase the object of said advertisement.

13. A method of providing advertising in a system for providing media content, the method comprising the steps of:
providing a graphical user interface with a plurality of media panels on the display, wherein each media panel displays media content;
querying a database, said database containing a table listing promotional items in association with promotion text data and data indicating a duration of time, wherein said promotional items are static graphics, active graphics, scrolling text, video, or audio advertisements;
displaying at least one of said promotional items in at least one of said media panels for a duration of time indicated by said data indicating a duration of time in association with the at least one of said promotional items;
displaying the promotion text data in association with the displayed promotional items.

14. The method of claim 13, wherein said promotional item is a video or audio advertisement, and said duration of time corresponds to the duration of the video or audio advertisement.

15. The method of claim 13, wherein said promotional item is an active graphic or scrolling text, and said duration of time corresponds to the time required for at least one cycle of said active graphic or scrolling text.

16. The method of claim 13, further comprising the step of accessing promotional items based on external criteria.

17. The method of claim 16 wherein said system for providing media content is in a hotel and said external criteria includes the time of day, characteristics of guests, interests of guests, and location of said hotel.

18. A system for providing media content comprising:
a means for providing audio and video signals;
a means for receiving said audio and video signals connected to said means for providing audio and video signals through a local area network;
a means for displaying said audio and video signals received by said means for receiving;
a means for sending control signals, wherein said control signals indicate the media content to be provided;
a means for receiving control signals from said means for sending control signals;
wherein the audio and video signals indicate a product or service for sale, and the means for sending control signals includes a selection key, and wherein the selection key is used to purchase the product or service for sale with a single push of the selection key.

19. The system of claim 18, further comprising a graphical user interface including menu options, wherein the menu options are navigable using the means for sending control signals, the means for sending control signals includes a directional controller, and the directional controller is used to navigate through the menu options.

20. The system of claim 19 wherein the graphical user interface includes a plurality of media panels with media contents on a display screen, and wherein a media content of at least one of said media panels changes in response to said control signals received by said means for receiving.
